(19) United States
(12) Patent Application Publication
(10) Pub. No.: US 2008/0259544 A1
(43) Pub. Date: Oct. 23, 2008

(54) DISPLAY APPARATUS

(75) Inventors: FENG XU, Shenzhen (CN); YONG-QIAN DENG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO.LTD., Shenzhen City (CN); HON HAI PRECISION INDUSTRY CO., LTD., Tu-Cheng (TW)

(21) Appl. No.: 11/923,662

(22) Filed: Oct. 25, 2007

(30) Foreign Application Priority Data
Apr. 20, 2007 (CN) 200720200286.3

(51) Int. Cl. G06F 1/16

(52) U.S. Cl. 361/681

(57) ABSTRACT

An exemplary display apparatus comprising a monitor having a frame and a built-in power transforming module; a support module having a terminal mounted on the frame of the monitor and another terminal; a luminescence module mounted on the another terminal of the support module, having an anode power cord and a cathode power cord coupled to the power transforming module; and a switch connected to the power transforming module to turn on/off the power transforming module. The present invention provides a monitor having illuminating function.

### BACKGROUND

1. Field of the Invention

The present invention relates to display apparatus, and particularly to a monitor having illuminating function.

2. Description of Related Art

Flat panel displays are more and more popularly used in offices. The relative lightness and compactness of flat panel displays (particularly in terms of front to back depth) make them particularly suitable for narrow workspaces. The characteristics of flat panel displays are particularly attractive in a small office/home office setting, because the relatively shallow front to back depth means that the display can be pushed back further from a user than would be possible with an equivalent cathode ray tube (CRT) monitor in many situations, taking up less precious desktop space in a user's work area. Additionally, falling prices of flat panel displays over the last several years, make them even more attractive to SOHO entrepreneurs.

Typically, other office equipment, such as desk lamps, telephones, printers, and so on, take up premium space on a desktop, to the point of being intrusive or at least inconvenient, adversely affecting work mood and efficiency in a SOHO. Though flat panel displays are increasingly selected for use in offices, desktop space is still at a premium, so desk lamps can particularly exacerbate the problem.

### SUMMARY

An exemplary display apparatus comprising a monitor having a frame and a built-in power transforming module; a support module having a terminal mounted on the frame of the monitor and another terminal; a luminescence module mounted on the another terminal of the support module, having an anode power cord and a cathode power cord coupled to the power transforming module; and a switch connected to the power transforming module to turn on/off the power transforming module.

Other advantages and novel features will become more apparent from the following detailed description when taken in conjunction with the accompanying drawings, in which:

### BRIEF DESCRIPTION OF THE DRAWINGS

FIG. 1 is an isometric view of one embodiment of a monitor with a desk lamp in accordance with the present invention;

FIG. 2 is a reverse view of FIG. 1;

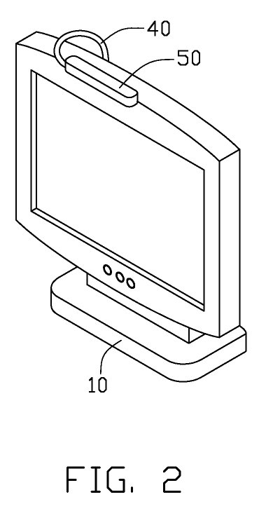

FIG. 3 is a circuit diagram of FIG. 1; and

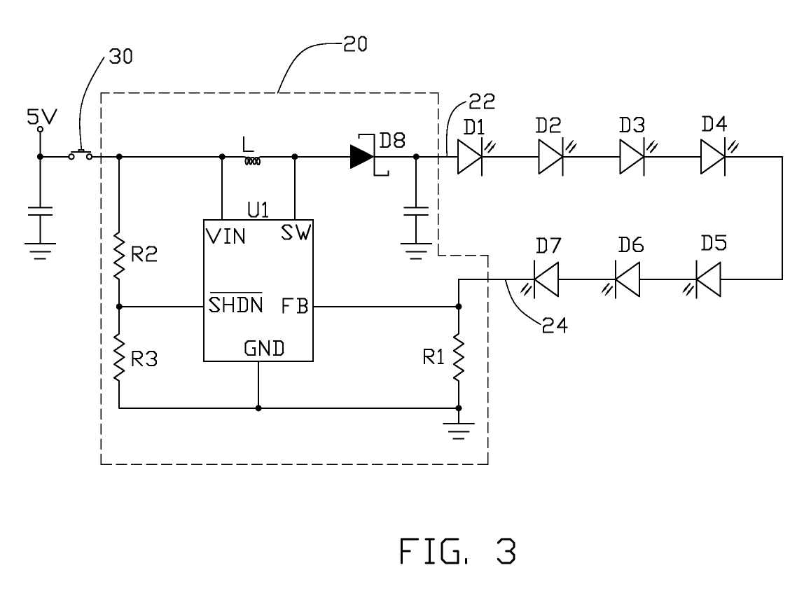

FIG. 4 is an isometric view of another embodiment of the present invention.

### DETAILED DESCRIPTION

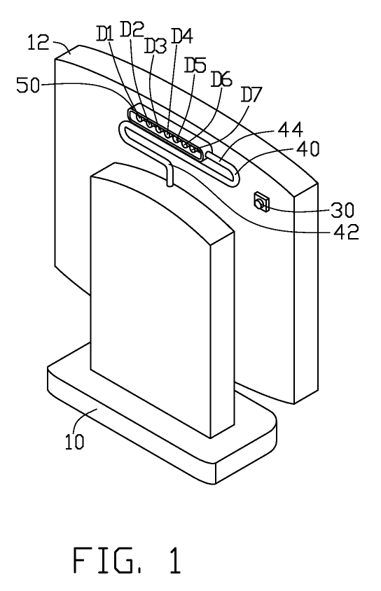

Referring to FIGS. 1˜3, a display apparatus in accordance with an embodiment of the present invention includes a monitor 10 having a frame 12 and a built-in power transforming module 20; a support module such as a flexible pipe 40 having a terminal 42 mounted on the frame 12 of the monitor 10; a luminescence module mounted on another terminal 44 of the flexible pipe 40, having an anode power cord 22 and a cathode power cord 24 coupled to the power transforming module 20; a switch 30 to turn on/off the power transforming module 20; and a lampshade 50 surrounding the luminescence module. The switch 30 is exposed through the back of the frame 12 of the monitor 10. The luminescence module includes seven light emitting diodes D1˜D7 connected in series between the anode power cord 22 and the cathode power cord 24. The flexible pipe 40 can be bent to the back or the front of the monitor 10.

In this embodiment, the power transforming module 20 includes a transformer U1, three resistors R1˜R3, an inductance L, and a Schottky diode D8. The transformer U1 includes an input pin VIN, an output pin SW, a feedback pin FB, a ground pin GND, and a control pin S̅H̅D̅N̅. The input pin VIN of the transformer U1 is connected to a 5V power source via the switch 30 and to the output pin SW via the inductance L. The control pin S̅H̅D̅N̅ of the transformer U1 is connected to the 5V power source via the resistor R2 and the switch 30, and is also grounded via the resistor R3. The ground pin GND is grounded. The output pin SW is connected to the anode power cord 22 of the luminescence module via the Schottky diode D8. The feedback pin FB is connected to the cathode power cord 24 of the luminescence module and is grounded via the resistor R1.

When the switch 30 is opened, the power transforming module 20 is turned off. When the switch 30 is closed, the power transforming module 20 is turned on, and the transformer U1 outputs 36 volts via the output pin SW to drive the luminescence module.

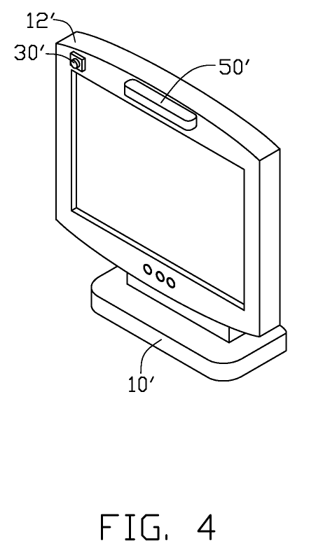

Referring to FIG. 4, in another embodiment of the present invention, a display apparatus includes a monitor 10′ having a frame 12′ and a built-in power transforming module (not shown), a lampshade 50′ directly mounted on the frame 12′ of the monitor 10′, a luminescence module mounted in the lampshade 50′ having power cords totally embedded in the frame 12′ and coupled with the power transforming module, and a switch 30′ connected to the power transforming module to turn on/off the power transforming module. The support module 40 of the previous embodiment is omitted.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A display apparatus comprising:
a monitor having a frame and a built-in power transforming module;
a support module having a terminal mounted on the frame of the monitor and another terminal;
a luminescence module mounted on the another terminal of the support module, having an anode power cord and a cathode power cord coupled to the power transforming module; and
a switch connected to the power transforming module to turn on/off the power transforming module.

2. The display apparatus as claimed in claim 1, further comprising a lampshade surrounding the luminescence module.

3. The display apparatus as claimed in claim 1, wherein the support module is a flexible pipe.

4. The display apparatus as claimed in claim 1, wherein the switch is exposed through the frame of the monitor.

5. The display apparatus as claimed in claim 1, wherein the luminescence module comprises a plurality of light emitting diodes connected in series.

6. The display apparatus as claimed in claim 1, wherein the power transforming module comprises a transformer having an input connected to a power source, an output connected to the input via an inductance and connected to a positive terminal of the luminescence module via a Schottky diode, a feedback terminal connected to a negative terminal of the luminescence module and ground.

7. The display apparatus as claimed in claim 6, wherein the switch is connected between the power source and the input of the transformer.

8. A display apparatus comprising:
a monitor having a frame and a built-in power transforming module;
a lampshade mounted on the monitor;
a luminescence module mounted in the lampshade, having power cords coupled to the power transforming module; and
a switch connected to the power transforming module to turn on/off the power transforming module.

9. A display apparatus comprising:
a monitor having a frame accommodating a display panel therein;
a power source supplying power to the display panel;
a luminescence module mounted on the frame via a support module; and
a switch exposed through the frame, the luminescence module connected to the power source via the switch.

10. The display apparatus as claimed in claim 9, further comprising a power transforming module connected between the luminescence module and the power source, to transform voltage of the power source to voltage suitable for the luminescence module.

11. The display apparatus as claimed in claim 10, wherein the power transforming module comprises a transformer having an input connected to the power source via the switch, an output connected to the input via an inductance and connected to a positive terminal of the luminescence module via a Schottky diode, a feedback terminal connected to a negative terminal of the luminescence module and ground.

12. The display apparatus as claimed in claim 11, wherein the luminescence module comprises a plurality of light emitting diodes connected in series between the positive terminal and the negative terminal.
